(19) United States
(12) Patent Application Publication
(10) Pub. No.: US 2010/0083237 A1
(43) Pub. Date: Apr. 1, 2010

(54) Reducing trace overheads by modifying trace operations

(75) Inventors: Katherine Elizabeth Kneebone, Cambridge (GB); Alastair David Reid, Cambridgeshire (GB); Edmund Grimley-Evans, Cambridge (GB)

Correspondence Address: NIXON & VANDERHYE P.C., 901 N. Glebe Road, 11th Floor, Arlington, VA, 22203-1808, US

(73) Assignee: ARM Limited, Cambridge (GB)

(21) Appl. No.: 12/285,016

(22) Filed: Sep. 26, 2008

(51) Int. Cl. G06F 9/45; G06F 9/44

(52) U.S. Cl. 717/128; 717/141

(57) ABSTRACT

A method of compiling a computer program to improve trace efficiency is disclosed. The computer program comprises a plurality of trace operations for triggering output of trace data generated by said computer program, and the method of compiling comprises the steps of: transforming said computer program into code forming an intermediate version of said computer program; analysing said transformed code; replacing at least some of said trace operations with modified trace operations; transforming said code into code suitable for execution on a data processing system; and generating translation data relating said modified trace operations to said trace operations they replaced.

### BACKGROUND OF THE INVENTION

1. Field of the Invention

The present invention relates to the field of data processing and in particular to the field of program behaviour monitoring.

2. Description of the Prior Art

Data processing apparatus are become increasingly complex and thus, it is getting more and more difficult to analyse their performance whether for optimisation or for fault finding without extracting and analysing large amounts of data.

A well known technique for monitoring program behaviour is to gather trace data that may be generated by the hardware or by code inserted into the program. Thus, at certain points in the program's execution in response to trace calls, trace data corresponding to the trace calls will be output. This trace data may indicate the state of the processor at that point, the values of particular variables and/or the time at which this trace call occurred.

There are, however, a number of drawbacks to monitoring a program's behaviour in this way. Inserting trace calls into the program can alter and distort its behaviour, while the inserted code increases both the size of the program and the time it takes to execute. Furthermore, large amounts of data can easily be generated in this way, and there is generally a limited bandwidth for transmitting the trace data from the hardware.

It would be desirable to be able to mitigate at least some of these disadvantages, while still collecting useful trace data.

### SUMMARY OF THE INVENTION

A first aspect of the present invention provides a method of compiling a computer program, said computer program comprising a plurality of trace operations for triggering output of trace data generated by said computer program, said method of compiling comprising the steps of: transforming said computer program into code forming an intermediate version of said computer program; analysing said transformed code; replacing at least some of said trace operations with modified trace operations; transforming said code into code suitable for execution on a data processing system; and generating translation data relating said modified trace operations to said trace operations they replaced.

The present invention recognises that when a computer program is compiled to produce an intermediate version or representation of the code, the ordering of at least some of the code is changed. Where the computer program code contains trace operations, then these trace operations may also be moved within the code and this may change their effectiveness. The present invention recognises that analysis of this intermediate version of the code enables redundancy in the trace operations, which is possibly due to the reorganisation of the code, to be identified and where appropriate removed. Thus, following the analysis certain identified trace operations are replaced by modified trace operations, for example trace operations that generate redundant data may be removed or merged with other trace operations. Analysis of the code and modifying the trace operations at this stage can result in a reduction in the number of trace operations within the code, making it more similar to uninstrumented code without any trace operations, it may also reduce the amount of trace operations that need to be processed thereby reducing processing overheads of the target system, and it may reduce the amount of redundant data generated reducing the bandwidth required for outputting trace data. The present invention also recognises that modification of the trace operations may make them incomprehensible to a system analysing the trace data and thus, it generates translation data indicating how the trace operations have been modified. This translation data allows the trace data output by the modified trace operations to be related to the trace operations that they replaced and thus, the modified code outputs trace data that can be understood by the use of the translation data. Thus, the present invention allows trace operations to be modified at the compiler stage enabling the more efficient generation and output of trace data.

In some embodiments, said method analyses said transformed code to determine said at least some trace operations whose replacement with modified trace operations would reduce a cost of execution of said trace operations, and selects said at least some trace operations to replace in dependence upon said analysis.

When analysing how to modify the trace operations, embodiments of this invention seek to reduce the cost of execution of the trace operation and thereby improve the efficiency of the trace when it is performed. By modifying the trace operations at compiler stage not only can less trace data be generated but the number of trace operations can be reduced which can reduce processing power, energy used and execution time. Thus, the present invention seeks to reduce costs associated with the trace, these costs may include the amount of trace data generated, the number of trace operations performed, the execution time and the power and energy required to generate the trace.

In some embodiments, said replacing step comprises replacing at least two of said trace operations with at least one modified trace operation.

Although a modified trace operation may replace a single original trace operation, the modified trace operation perhaps generating less trace data, in some embodiments a modified trace operation is generated by merging several trace operations. Thus, two trace operations may be replaced by a single modified trace operation, or a plurality of trace operations may be replaced by fewer modified trace operations. This reduces the number of trace operations that are performed and may also reduce the amount of trace data output if some of the several trace operations replaced output the same data.

In some embodiments, said analysing step comprises identifying at least two trace operations within a basic block of said intermediate version of code, said basic block being a block of code within which if one instruction is executed all of said instructions will be executed, and said replacing step comprises replacing said at least two trace operations with at least one of said modified trace operations.

An example of trace operations that can be merged is trace operations within a basic block of the intermediate version of the code. A basic block is a block of code within which if one instruction is executed all of the instructions will be executed. Thus, trace operations that are found in the same basic block will all be executed and thus, can be merged into fewer trace operations.

In some embodiments, said replacing step comprises replacing at least one of said trace operations with at least one modified trace operation and associated timestamp correction data indicating when said at least some trace operations would have executed with respect to execution of said modified trace operations.

Trace data may contain timestamps indicating when the trace operation was performed. Thus, if an original trace operation would have contained timestamp data, it may be advantageous if the translation data associated with the modified trace operations also contains timestamp data indicating when the original trace operations that the modified trace operation replaces would have executed with respect to execution of the modified trace operation.

In some embodiments, said step of generating translation data comprises generating an estimate of a number of cycles between execution of each of said trace operations and said modified trace operations that replaced them.

One way of calculating when the original trace operations would have executed with respect to the modified trace operations is to estimate a number of cycles between the operations and to include this estimate in the translation data. Thus, if the modified trace operation includes timestamp data an estimate of when the individual trace operations would have produced their trace data can be made.

In some embodiments, said replacing step comprises replacing at least one of said trace operations with a modified trace operation that outputs less data than is output by said at least one trace operation.

The modified trace operations replace other trace operations in order to reduce the cost of execution of the trace operations, and this may be by outputting less data than was output by the original trace operations. Analysis of the code at the intermediate version stage may identify that some of the data output is redundant data, that is data that is the same as data already output or data that can be calculated from data already output. If this is the case, then this data does not need to be output provided the translation data generated enables it to be derived from the data that is output.

In some embodiments, said replacing step comprises replacing at least one of said trace operations with a modified trace operation that requires said computer program to perform fewer processing steps than said at least one trace operation required.

Another cost that can be reduced is the cost due to processing steps and the modified trace operation might be such that it requires a computer to perform fewer processing steps than the trace operation(s) that it replaced. For example, a trace operation may require a product of two variables to be output, which means the target system will need to calculate this value. If processing power on the target system is at a premium, it may be advantageous to output the two values individually and calculate the product on the system analysing the trace data.

In some embodiments, at least one of said trace operations comprises tag data, indicating an extent to which said trace operation can be moved when being replaced by one of said modified trace operations, said step of replacing being responsive to said tag data when determining which trace operations to replace.

Tag data might be associated with the trace operations. This tag data is data that provides hints or directives to the compilers and is not present in the final compiled version of the code. This tag data may include data indication an extent to which the trace operation can be moved during modification. When analysing the intermediate version of the code and replacing trace operations with modified trace operations this tag data is considered such that a modified trace operation replacing an original trace operation having tag data is not further than the allowed amount from this original trace operation.

In some embodiments, said computer program comprises barrier indications across which trace operations cannot be moved to form modified trace operations.

Further information that is present as a hint or directive to the compiler might be barrier indications which could take a number of forms, and may for example be instructions. These can be inserted into the program to instruct the compiler not to move trace operations across them. Similarly to the tag data these are deleted from the final version of the compiled code, but are used by the compiler to help it reorganise the code in a correct manner.

In some embodiments, said method comprises a further step of including code within said transformed program for controlling a processor executing said code to output said translation data.

It may be that the translation data that is generated is output with the transformed code in which case the transformed code should include a step controlling a processor executing the code to output the translation data. In this way, the translation code will be available to the analyser via the processor executing the compiled code. In other embodiments, the translation data is made available to the analyser in a different way, for example via a data store. This latter may be the case where the apparatus compiling the code and analysing the trace data are the same apparatus. Alternatively, the translation data may be embedded within the program binary, but not output when executed. For example, it may be in the form of a debug table associated with the binary which is read from a separate copy of the binary on the analyser analysing the trace data.

In some embodiments said method comprises the further two steps of: following said step of replacing said at least some trace operations with modified trace operations, analysing said modified code; replacing at least some of said trace operations or modified trace operations with modified trace operations; and repeating said two steps until said step of analysing said modified code indicates said modified code not to reduce significantly a cost of execution of said trace operations when compared with previously modified code.

The modification of the trace operations could be done recursively, so that they are modified and the modified code is analysed and further modifications made, until a point at which the further modifications no longer make significant cost savings. It should be noted that the trace operations replaced in further steps may be original trace operations and/or those that have already been modified in previous steps. The point at which the further modifications no longer make significant cost savings could be judged by comparing the number of processing steps required and finding they are not reduced, or comparing the speed of execution and finding that this is not reduced by more than a predetermined amount, which is judged to be insignificant.

A second aspect of the present invention provides a method of monitoring program behaviour comprising: receiving trace data and translation data, said trace data being trace data output in response to trace operations executed by said program being monitored, said translation data comprising data corresponding to at least some of said trace operations, said at least some of said trace operations being modified trace operations; identifying trace data generated in response to said modified trace operations; and translating said identified trace data using said translation data to generate translated trace data representative of trace data that would have been output by trace operations present in a version of said program prior to it being modified.

Trace data that is generated by a program that has been compiled according to a first aspect of the present invention can be understood and analysed by using the translation data that is also generated by the first aspect of the present invention. Thus, trace data generated by modified trace operations is identified and the relevant translation data is found and the modified trace data can then be reconstructed to form trace data representative of trace data that would have been output by trace data operations present in a version of the program and prior to it being modified. This trace data can then be analysed.

Although the translated trace data that is representative of the trace data that would have been output by trace operations present in a version of the program prior to it being modified can take a number of forms provided that it is sufficiently similar to the original trace data to enable it to be analysed by tools expecting the original data, in some embodiments it is identical to the original trace data in all aspects except for the timestamps that may be slightly different, although in some embodiments it may be possible to guarantee that these too are equivalent.

In some embodiments, the method comprises the further step of analysing said program behaviour using said trace data.

Once the trace data has been amended into a form similar to the original trace data it can be analysed either by conventional tools that expected the original trace data or by tools for analysing this particular compiled code.

In some embodiments, said translation data is received with said-trace data from said system being monitored, while in other embodiments the translation data is stored on the analysing system, or it is put in a file in an agreed place, or put into a section of the executable file or it could be part of the memory image of the program referred to by the analysing system.

A third aspect of the present invention provides a method of analysing behaviour of a computer program executing on an embedded system, said computer program comprising a plurality of trace operations for triggering output of trace data generated by said computer program, said method comprising the steps of: transforming said computer program into code forming an intermediate version of said computer program; analysing said transformed code; replacing at least some of said trace operations with modified trace operations; transforming said code into code suitable for execution on a data processing system; generating translation data relating said modified trace operations to said trace operations they replaced, to allow interpretation of trace data output in response to said modified trace operations; outputting said transformed code to said data processing system; outputting said translation data to a program monitoring apparatus; executing said transformed code on said data processing system; receiving trace data from said data processing system at said program monitoring apparatus; identifying within said trace data, trace data generated in response to said modified trace operations; translating said identified trace data using said translation data to generate trace data representative of trace data that would have been output by a trace operation present in a version of said program prior to it being modified; analysing said program behaviour using said trace data.

The compiling of the code and then the analysing of the generated trace data can be performed on a single apparatus.

A fourth aspect of the present invention provides a computer program for controlling a data processing apparatus to perform the steps of the method of the first aspect to the present invention.

A fifth aspect of the present invention provides a computer program for controlling a data processing apparatus to perform the steps of the method of the second aspect of the present invention.

A sixth aspect of the present invention provides a compiler for compiling a computer program which comprises a plurality of trace operations for triggering output of trace data generated by said computer program, said compiler comprising: transforming circuitry for transforming said computer program into code forming an intermediate version of said computer program; analysing circuitry for analysing said transformed code; wherein said transforming circuitry is responsive to an analysis performed by said analysing circuitry to replace at least some of said trace operations with modified trace operations and to transform said code into code suitable for execution on a data processing system and to generate translation data relating said modified trace operations to said trace operations they replaced.

A seventh aspect of the present invention provides an analysing apparatus for monitoring program behaviour comprising: an input for receiving trace data and translation data, said trace data being trace data output in response to trace operations executed by said program being monitored, said translation data comprising data corresponding to at least some of said trace operations, said at least some of said trace operations being modified trace operations; identifying circuitry for identifying trace data generated in response to said modified trace operations; translating circuitry for translating said identified trace data using said received translation data to generate translated trace data representative of trace data that would have been output by trace operations present in a version of said program prior to it being modified.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically shows a data processing apparatus for monitoring the behaviour of a computer program processed by an embedded system;

FIG. 2 shows a data processing apparatus for compiling code comprising trace operations;

FIG. 3 shows some examples of trace operations modified to form modified trace operations;

FIG. 4 is a flow diagram illustrating steps in a method for converting modified trace data to conventional trace data prior to analysing it; and

FIG. 5 is a flow diagram showing steps in a method for modifying trace data during compilation of a computer program.

### DESCRIPTION OF THE PREFERRED EMBODIMENTS

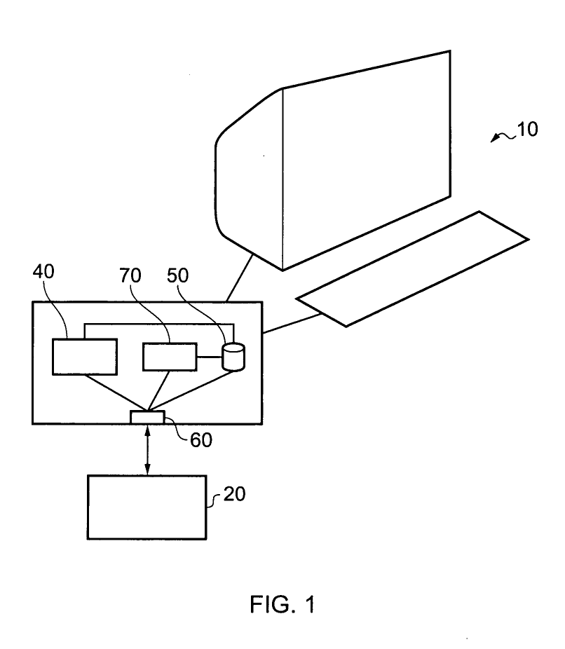

FIG. 1 shows a data processing apparatus 10 for monitoring the behaviour of a computer program being executed by embedded system 20. The program to be analysed is compiled by compiler 40.

The computer program has trace operations within the program code which when processed trigger the output of trace data. These operations may be many different things, including “trace call” instructions, function calls, inlined function calls, macros and special machine code instructions, the trace data output depending on the trace operation.

During compilation by compiler 40 the program is transformed into an intermediate version or representation of the code. This transformation may involve functions and instructions being moved around within the code.

In addition to rearranging the code to put it into a suitable form for execution by embedded system 20, compiler 40 modifies at least some of the trace operations to try to reduce overheads associated with them. These overheads may include the amount of trace data generated, the numbers of trace operations, and the processing power required.

This reduction in overheads involves avoiding or at least reducing the generation of redundant trace data, merging trace operations together and in some embodiments changing the trace data output to reduce processing requirements on the target system. Thus, trace calls that due to the rearrangement of the program code now occur near to each other within the same basic block can be merged to form a single modified trace call. Furthermore, if two arguments x and y are output by one trace call and then their product is output by a second trace call the trace calls can be merged so that only the first trace call is output and the multiplication of the two values is performed by the analyser (host debugger) that analyses the trace rather than the target system 20. Such merging of trace calls has the advantages of increasing the speed of processing of the code by the target system 20 and making the execution of the code more similar to the execution of the original program without trace operations.

Thus, compiler 40 compiles the program to be tested and modifies the trace operations within the code. The modification of the trace operations may be done recursively, in that the set of modified trace operations may be amended several times, and the transformed code analysed until no further or only insignificant cost savings associated with the trace are found. These cost savings are savings in the costs of execution of the trace operations and include reductions in generated trace data, number of trace operations processing power, energy used and execution time. The compiled code is then output by compiler 40 and sent to embedded system 20 for execution. In addition to producing compiled code with modified trace operations, compiler 40 also generates a translation table which contains information relating the modified trace operations to the trace operations from which they were generated. In this embodiment, this translation table is sent directly to data store 50 on data processing apparatus 10. In other embodiments it may be sent to the embedded system 20 with the compiled code. This might be appropriate where the code is compiled on one system and analysed on a different system.

The compiled code is then executed by the embedded system 20 and trace data generated by the trace operations within the compiled code are output from the embedded system and are received at interface 60. This trace data is then analysed by analyser 70 within data processing apparatus 10. Analyser 70 also accesses the translation table that is stored in data store 50. Thus, analyser 70 looks at the trace data and any trace data that corresponds to a trace call that it was not expecting, i.e. one that was not present in the original code it reconstructs using the translation table stored in data store 50 to a form that is related to a form that would have been generated by the trace calls had they not been modified and that it can therefore understand. It may be that the reconstructed trace data is identical to the trace data that would have been output by the unmodified trace calls, or it may be the same except for timestamp data. It can then analyse this trace data using conventional analysis techniques.

In order to be able to identify the appropriate translation data within the translation table, data identifying a modified trace operation is output with the trace data it generates, this identifying data is also stored with the translation data in the translation table.

By modifying trace operations in this way, compiler 40 reduces at least some of the number of trace calls made, the trace data output and the processing overhead of the embedded system 20.

Although not shown in this embodiment, additional compression techniques may be used to reduce the data output by embedded system 20.

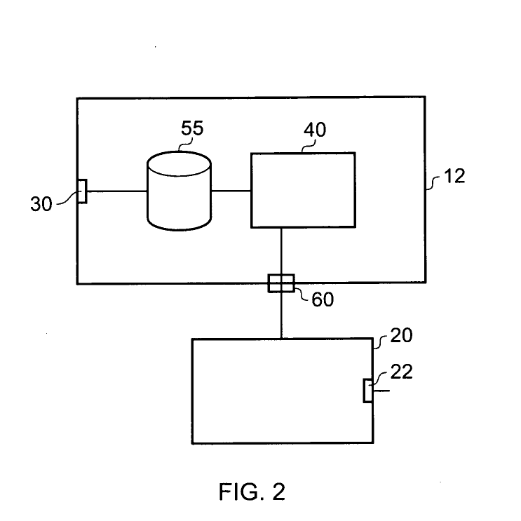

FIG. 2 shows an alternative embodiment of the present invention in which a compiler 40 in data processing apparatus 12 compiles the program that is stored in data store 55 and while compiling the program modifies trace operations within the program in a similar way to the-apparatus of FIG. 1. In this embodiment however data processing apparatus 12 that compiles the program is not the apparatus that analyses it. Thus, the translation table that is generated as a code book for the modified trace calls is output by compiler 40 along with the compiled code via interface 60 to the embedded system 20. The compiled code contains an instruction instructing the processor to output the translation table. Thus, embedded system 20 when connected via output 22 to an analysing system, runs the compiled code and in response to this code outputs a translation table via trace output 22 along with the generated trace data. This trace data can then be analysed by this separate system using the translation table.

In some embodiments the separate system is a conventional trace analyser with an additional block that uses the translation table to convert the trace data generated by the modified trace operations to trace data that would have been output by the original trace operations. Once this conversion has been performed then the conventional trace analyser can analyse the trace data.

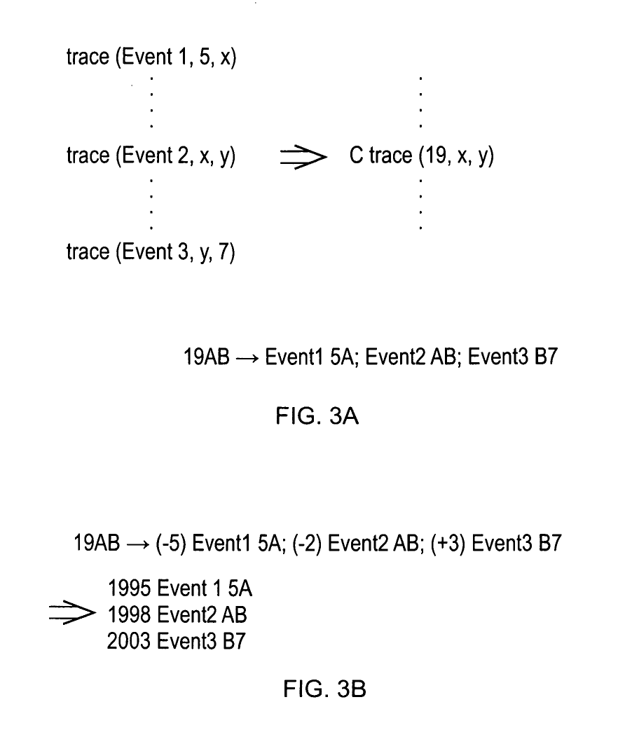

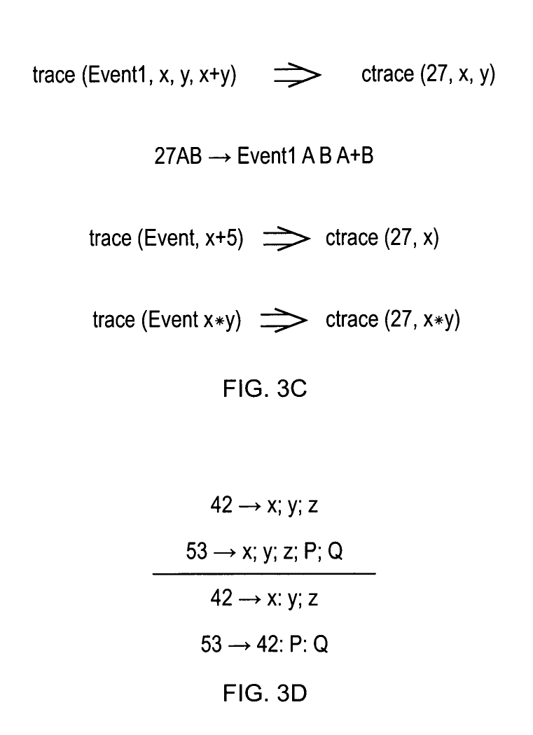

FIG. 3 shows some examples of trace operations modified to form modified trace operations. FIG. 3a shows three trace events that in this embodiment are in a basic block within the intermediate representation of the code that the compiler has generated. The compiler realising that these three events are within the same basic block so that if one is executed they will all be executed, and that they contain arguments that are not going to vary between execution of the individual trace calls, combines these trace calls to generate a new compressed trace call which in this case is denoted by ctrace 19,x,y. 19 is the identifying data for this modified trace call while x and y are the arguments that are output. These arguments are the arguments that were output by the original three trace calls.

In addition to generating this compressed trace call the compiler also creates a table that allows the modified trace data to be translated back to the trace data that the unmodified program would have transmitted. In this case, the table entry corresponding to this modified trace call would if translated into a human readable form look as shown in FIG. 3a. Thus, it identifies 19 as being a modified trace call and AB as the arguments that are output by it. Thus, when a trace event marked as 19 is received along with two arguments (AB) the analyser can match these to the event1 that it was expecting and generate trace data of a 5 and the first argument A, as trace data corresponding to the original unmodified trace call-event1. It can also match it to the second trace call event2 that it was expecting and generate trace data of the two arguments received with the modified trace call A and B (corresponding to x and y). It can also match it to the third trace call event3 that it was expecting and that would have output the second argument i.e. B and the number 7.

Generally trace data also has timestamps attached to it and it may be that the system requires the timestamps to be unique or reflect the originally expressed order of the trace operations. In such a case, when translating the modified trace data back to the original form the analyser may add extra fields to the timestamp received with that modified trace event. Thus, if modified trace event 19 has a timestamp 2000, timestamps generated for the three original trace calls could be 2000.1 for event1, 2000.2 for event2 and 2000.3 for event3. Alternatively in other embodiments, the compiler may estimate the number of cycles between the separate calls in the unmodified code and include the information in the table as is shown in the FIG. 3b. Here event1 is estimated as occurring 5 cycles before the modified trace instruction event19, while event2 is estimated as occurring 2 cycles before and event3 as 3 cycles later. Thus, as the modified trace data had a timestamp indicating it occurred at 2000, the original trace data can be reconstructed as shown.

Estimating times like this could result in some timestamps and separate modified events overlapping so a mechanism might be needed to tweak the timing in such a case to conserve the correct ordering of the events. Such a tweaking could be built into the compiler.

Alternative trace calls that can be modified are shown in FIG. 3c, these are concerned with reducing the amount of data that is output and also the amount of processing required by the target system being tested. In this case, the compiler recognises that outputting data x y and x+y is not necessary and that simply outputting x and y along with translation data that indicates that the original trace call would have output x y and x+y enables the debug host to generate the additional data from the reduced data that is output.

In other embodiments where a trace call requires an argument plus a particular value or two arguments multiplied together to be-output, it may be desirable to output these values individually and perform the processing step combining them on the debug host rather than on the target system. In some situations this can result in an increase in the amount of trace data output, but this may be acceptable where it is important to reduce the processing requirement of the target system. It should be noted that if the multiplied value of the arguments is required by the program for some reason other than trace, then in such a situation the multiplied value should be output as the target system needs to perform the multiplication steps in any case and outputting the multiplied value reduces the data output and processing performed on the debug host.

Compression of the translation data can also be performed. If for example translated event 42 corresponds to original events X, Y, Z and translated even 53 corresponds to translated events X, Y, Z, P, Q then FIG. 3d shows how the translation table data required to represent event 53 can be reduced by using the information that is present for event 42.

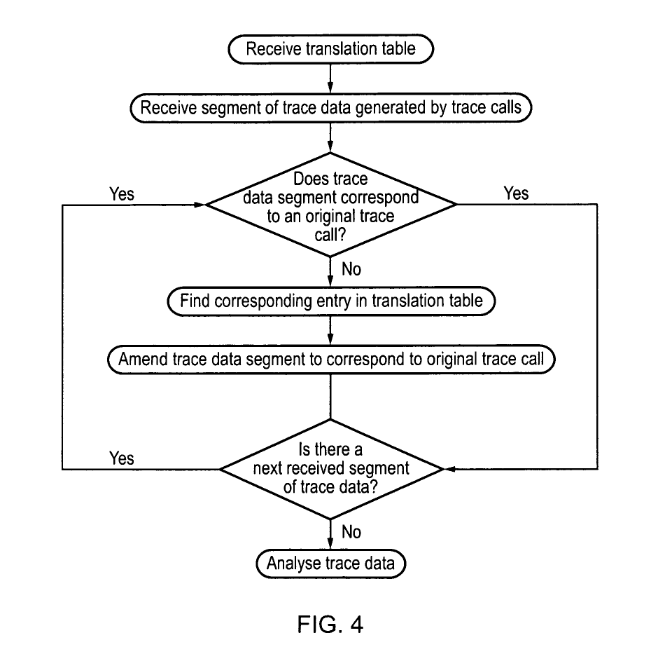

FIG. 4 shows a flow diagram illustrating a method of converting the modified trace data to conventional trace data and then analysing it. The trace data is received along with a translation table. The trace data is then analysed and each set or segment of trace data generated by a trace call is checked to see if it corresponds to a trace call that is present in the original program. If it does, then the next trace data segment is checked. If not then the translation table is read and the translation data corresponding to this operation is accessed and the trace data modified to correspond to trace data that would have been output by the original program. It should be noted that it may not be modified to be identical to trace data that would have been output by the original trace call, but it will be sufficiently similar so that it can be analysed by tools that expected the original trace data. For example, if the trace data contains timestamps, it may be that these are not exactly the same as the timestamps that would have been output by the original calls, however, they are sufficiently similar for the code to be analysed.

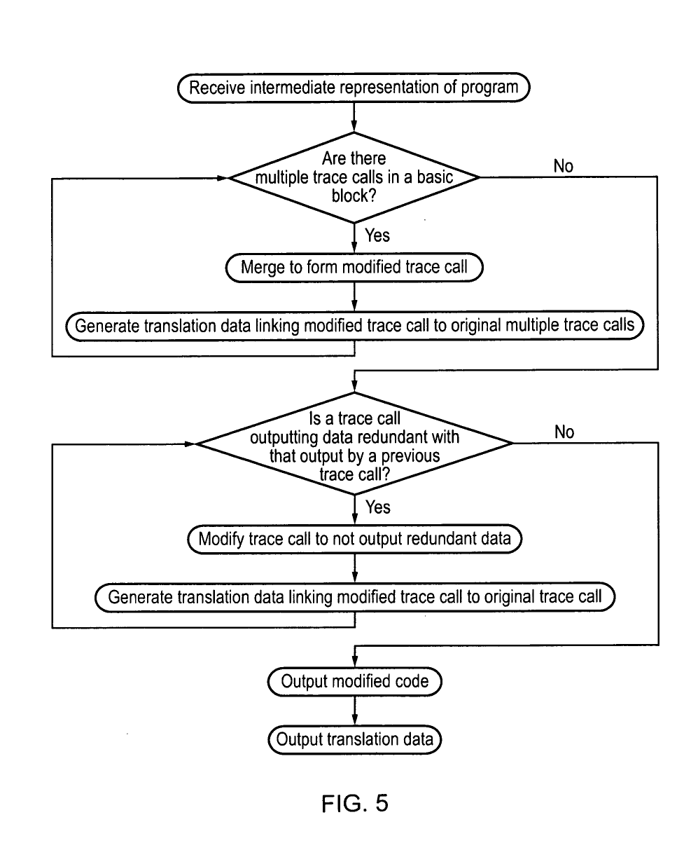

FIG. 5 illustrates some steps of a method of modifying trace calls in code to reduce the number of trace calls in the code and the trace data output. It should be noted that the steps shown are not necessarily performed in the order shown and some of the steps may be performed in parallel with each other. In the example shown multiple trace calls in a basic block are merged to form a single-modified trace call, thereby reducing the number of trace calls in the code and possibly reducing the amount of data output. Furthermore trace calls outputting redundant data are also identified and modified so that the redundant data is not output.

Further optimisation steps, not shown, may be performed on the code. For example trace events that are tagged as being idempotent may be detected and where there are adjacent instances of the same event only one of them need be emitted, thus the other can be deleted. It should be noted that this may have already been dealt with by the regular merging process. Furthermore, there may be barrier instructions or tags to certain trace operations indicating the limits beyond which these operations should not be moved. When deciding on merging trace calls, no mergers are made beyond these specified limits. Additionally some trace events may have tags that indicate whether they are to be turned on or off and when modifying the trace calls, these tags are analysed and if the trace call is to be turned off it is deleted from the code.

In some embodiments there may be a limit on the number of events that can be emitted by the trace data, and generating modified trace events may increase the number of events. Where this limit is an issue, when determining which trace events or calls to modify additional steps to those shown in the figure may be performed to prevent the limit from being exceeded. In such a case the compiler analyses the code and computes the frequency of various events so that it can make the most efficient use of the available event codes, only producing modified events that occur relatively frequently or reduce a large number of trace operations or trace data output. This is done to try to get the best value from the encoding space.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims. For example, various combinations of the features of the following dependent claims could be made with the features of the independent claims without departing from the scope of the present invention.

We claim:

1. A method of compiling a computer program, said computer program comprising a plurality of trace operations for triggering output of trace data generated by said computer program, said method of compiling comprising the steps of:
transforming said computer program into code forming an intermediate version of said computer program;
analysing said transformed code;
replacing at least some of said trace operations with modified trace operations;
transforming said code into code suitable for execution on a data processing system; and
generating translation data relating said modified trace operations to said trace operations they replaced.

2. A method according to claim 1, wherein said method analyses said transformed code to determine said at least some trace operations whose replacement with modified trace operations would reduce a cost of execution of said trace operations, and selects said at least some trace operations to replace in dependence upon said analysis.

3. A method according to claim 1, wherein said replacing step comprises replacing at least two of said trace operations with at least one modified trace operation.

4. A method according to claim 3, wherein said analysing step comprises identifying at least two trace operations within a basic block of said intermediate version of code, said basic block being a block of code within which if one instruction is executed all of said instructions will be executed, and said replacing step comprises replacing said at least two trace operations with at least one of said modified trace operations.

5. A method according to claim 1, wherein said replacing step comprises replacing at least one of said trace operations with at least one modified trace operation and associated timestamp correction data indicating when said at least some trace operations would have executed with respect to execution of said modified trace operations.

6. A method according to claim 1, wherein said step of generating translation data comprises generating an estimate of a number of cycles between execution of each of said trace operations and said modified trace operations that replaced them.

7. A method according to claim 2, wherein said replacing step comprises replacing at least one of said trace operations with a modified trace operation that outputs less data than is output by said at least one trace operation.

8. A method according to claim 2, wherein said replacing step comprises replacing at least one of said trace operations with a modified trace operation that requires said computer program to perform fewer processing steps than said at least one trace operation required.

9. A method according to claim 1, wherein at least one of said trace operations comprises tag data indicating an extent to which said trace operation can be moved when being replaced by one of said modified trace operations, said step of replacing being responsive to said tag data when determining which trace operations to replace.

10. A method according to claim 1, wherein said computer program comprises barrier indications across which trace operations cannot be moved to form modified trace operations.

11. A method according to claim 1, comprising a further step of including code within said transformed program for controlling a processor executing said code to output said translation data.

12. A method of compiling a computer program, according to claim 2, said method comprising the further two steps of:
following said step of replacing said at least some trace operations with modified trace operations, analysing said modified code,
replacing at least some of said trace operations or modified trace operations with modified trace operations;
and repeating said two steps until said step of analysing said modified code indicates said modified code not to reduce significantly a cost of execution of said trace operations when compared with said previously modified code.

13. A method of monitoring program behaviour comprising:
receiving trace-data and translation data, said trace data being trace data output in response to trace operations executed by said program being monitored, said translation data comprising data corresponding to at least some of said trace operations, said at least some of said trace operations being modified trace operations;
identifying trace data generated in response to said modified trace operations;
translating said identified trace data using said translation data to generate translated trace data representative of trace data that would have been output by trace operations present in a version of said program prior to it being modified.

14. A method of monitoring program behaviour according to claim 13, wherein said translated trace data is identical to trace data that would have been output by trace operations present in a version of said program prior to it being modified except for any timestamp data.

15. A method of monitoring program behaviour according to claim 13, comprising the further step of analysing said program behaviour using said trace data.

16. A method of monitoring program behaviour according to claim 13, wherein said translation data is received with said trace data from said system being monitored.

17. A method of analysing behaviour of a computer program executing on an embedded system, said computer program comprising a plurality of trace operations for triggering output of trace data generated by said computer program, said method comprising the steps of:
transforming said computer program into code forming an intermediate version of said computer program;
analysing said transformed code;
replacing at least some of said trace operations with modified trace operations;
transforming said code into code suitable for execution on a data processing system;
generating translation data relating said modified trace operations to said trace operations they replaced, to allow interpretation of trace data output in response to said modified trace operations;
outputting said transformed code to said data processing system;
outputting said translation data to a program monitoring apparatus;
executing said transformed code on said data processing system;
receiving trace data from said data processing system at said program monitoring apparatus;
identifying within said trace data, trace data generated in response to said modified trace operations;
translating said identified trace data using said translation data to generate trace data representative of trace data that would have been output by a trace operation present in a version of said program prior to it being modified;
analysing said program behaviour using said trace data.

18. A computer program for controlling a data processing apparatus to perform the steps of the method according to claim 1.

19. A computer program for controlling a data processing apparatus to perform the steps of the method according to claim 13.

20. A compiler for compiling a computer program which comprises a plurality of trace operations for triggering output of trace data generated by said computer program, said compiler comprising:
transforming circuitry for transforming said computer program into code forming an intermediate version of said computer program;
analysing circuitry for analysing said transformed code; wherein
said transforming circuitry is responsive to an analysis performed by said analysing circuitry to replace at least some of said trace operations with modified trace operations and to transform said code into code suitable for execution on a data processing system and to generate translation data relating said modified trace operations to said trace operations they replaced.

21. An analysing apparatus for monitoring program behaviour comprising:
an input for receiving trace data and translation data, said trace data being trace data output in response to trace operations executed by said program being monitored, said translation data comprising data corresponding to at least some of said trace operations, said at least some of said trace operations being modified trace operations;
identifying circuitry for identifying trace data generated in response to said modified trace operations;
translating circuitry for translating said identified trace data using said received translation data to generate translated trace data representative of trace data that would have been output by trace operations present in a version of said program prior to it being modified.
